(19) United States
(12) Patent Application Publication
(10) Pub. No.: US 2022/0358538 A1
(43) Pub. Date: Nov. 10, 2022

(54) System for Creating, Managing and Analyzing Marketing Promotions

(71) Applicant: Slaashh, LLC, Miami, FL (US)

(72) Inventor: Jennifer Perkins, Miami, FL (US)

(73) Assignee: Slaashh, LLC, Miami, FL (US)

(21) Appl. No.: 17/741,354

(22) Filed: May 10, 2022

Related U.S. Application Data
(60) Provisional application No. 63/186,686, filed on May 10, 2021.

(51) Int. Cl. G06Q 30/02; G06Q 30/06

(52) U.S. Cl. CPC G06Q 30/0253; G06Q 30/06

(57) ABSTRACT

Systems and methods for creating, managing, and analyzing marketing promotions are described. A bar code generator generates a bar code related to a deal offered by a merchant, wherein the deal includes deal data related to an offer to sell a good or service. The system also includes a bar code reader for reading the bar code. The remote server includes a deal database in which the deal data is stored. A deal transaction request process creates and transmits a deal transaction request via a telecommunications network from a customer computing device to the merchant computing device, and a deal transaction approval process receives the deal transaction request from the deal transaction request process and approves or rejects the deal transaction request. A notification process transmits an approval or rejection notification to the customer computing device as an alert that the deal transaction request has been accepted or rejected.

### CROSS REFERENCE TO RELATED APPLICATIONS

This application is a nonprovisional application of and claims priority from U.S. provisional patent application Ser. No. 63/186,686 filed on May 10, 2021. The foregoing application is incorporated in its entirety herein by reference.

### FIELD OF THE INVENTION

The invention relates to systems, software, and methods for marketing. More particularly, the invention relates to systems and methods for creating, managing, and analyzing marketing promotions.

### BACKGROUND

Online retail store sales have increased dramatically over the last decade and may one day surpass sales made in brick-and-mortar stores. Many retail businesses, and particularly small businesses, which sell products like clothing, electronics, cosmetics, personal care products, toys, and other consumer goods, have migrated to online e-commerce platforms like Amazon, Walmart, Etsy, and Shopify. Such e-commerce platforms provide an advantage by serving the function that traditional shopping malls have served, namely, drawing a multitude of shoppers to a central (in the case of e-commerce, online) location (or website) at which multiple vendors sell or provide goods and services. Many such e-commerce platforms have become so large in terms of the number of vendors selling goods and services through them that merchants have difficulty in attracting the attention of customers amid the plethora of vendor and product options on such sites. Often, those e-commerce platforms lack the ability to allow vendors to advertise and market their goods and services by offering deals, discounts, benefits, or complimentary items for making purchases, either online or in a store, from a particular vendor. Vendors selling their goods and services through existing e-commerce platforms also find that these large e-commerce platforms compete with the vendors for sales through the vendors' own websites and stores.

Other websites aggregate deals and discounts provided by various vendors from other websites but do not provide the vendors with any ability to control, modify, or administer new, existing, or ongoing marketing campaigns that make use of such deals and discounts. As with e-commerce platforms, these discount aggregators also do not permit vendors to create and manage their new, existing, or ongoing marketing campaigns that make use of such deals and discounts when such offerings are in-store, online, or both.

A need exists for systems, software, and methods for creating, managing, and analyzing marketing promotions that allow a vendor to offer deals, discounts, benefits, or complimentary items to customers for making purchases from the vendor either online or in-store. A further need exists for an e-commerce platform that allows multiple vendors to make such offers to customers or to potential customers via a website that attracts a multitude of customers with shopping needs while permitting the vendors to create, administer, modify, and control marketing campaigns that make use of offerings such as deals, discounts, benefits, or complimentary items that are offered to the customers online, in-store, or both.

### SUMMARY

The invention relates to systems and methods for creating, managing, and analyzing marketing promotions. The system provides a platform for merchants to acquire new customers and to market and promote their business, products, and services to new and existing customers by offering deals (referred to herein as “deal offers” or simply as “deals”). The system includes a bar code generator, a merchant computing device, a customer computing device, a remote server, and a telecommunications network. The system also includes a deal transaction request process, a deal transaction approval process, and a notification process. One or more of the foregoing processes may be installed on the remote server, although in some embodiments, one or more of the processes may be installed on the merchant computing device or the customer computing device. The bar code generator generates a bar code related to a deal offered by a merchant, wherein the deal includes deal data related to an offer to sell a good or service. The bar code may be displayed by the customer computing device or by the merchant computing device. In some embodiments, the bar code may be printed and displayed at a point-of-sale, e.g., in a brick-and-mortar store or at a kiosk or vending machine. The customer computing device, the merchant computing device, or both includes a bar code reader for reading the bar code. The remote server includes a deal database in which the deal data is stored. The deal transaction request process creates and transmits a deal transaction request via a telecommunications network from a customer computing device to the merchant computing device, and the deal transaction approval process receives the deal transaction request from the deal transaction request process and approves or rejects the deal transaction request. The notification process transmits an approval or rejection notification to the customer computing device as an alert that the deal transaction request has been accepted or rejected.

The systems, software, and methods for creating, managing, and analyzing marketing promotions, which are described herein, provide an advantage over other e-commerce platforms and discount aggregation websites by allowing a vendor to offer deals, discounts, benefits, or complimentary items to customers for making purchases from the vendor either online or in-store. These systems, software, and methods also have an advantage by providing an e-commerce platform that allows multiple vendors to make such offers to customers or to potential customers via a website that attracts a multitude of customers with shopping needs while permitting the vendors to create, administer, modify, and control marketing campaigns that make use of offerings such as deals, discounts, benefits, or complimentary items, which are offered to the customers online, in-store, or both.

Accordingly, the invention relates to a system for creating, managing, and analyzing marketing promotions. The system includes a bar code generator, a merchant computing device, a customer computing device, a remote server, and a telecommunications network. The bar code generator generates a bar code related to a deal offered by a merchant, wherein the deal includes deal data related to an offer to sell a good or service of the merchant. The merchant computing device includes a processor and associated memory. The customer computing device includes a processor and associated memory. The system also includes a bar code reader for reading the bar code, wherein the bar code reader is communicatively connected to the merchant computing device or the customer computing device. The remote server includes a deal database in which the deal data related to the deal is stored. The telecommunications network connects the merchant computing device and the customer computing device to the remote server. The system also includes a deal transaction request process for creating and transmitting a deal transaction request from the customer computing device of a customer to the merchant computing device of the merchant. The system also includes a deal transaction approval process, installed on the remote server, for receiving the deal transaction request from the deal transaction request process and for approving or rejecting the deal transaction request. The system further includes a notification process, installed on the remote server, for transmitting an approval notification or a rejection notification to the customer computing device to alert the customer as to whether the merchant has accepted or rejected the deal transaction request.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a screenshot of a merchant portal of a system for creating, managing, and analyzing marketing promotions.

FIGS. 2A-2C are screenshots of deal offers displayed in an app of the system of FIG. 1 on a customer computing device.

FIG. 3 is a transaction confirmation page displayed in the app of the system of FIG. 1.

FIG. 4 is a screen shot of a bar code of a merchant displayed on a merchant website.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides systems, software, and methods for creating, managing, and analyzing marketing promotions. Marketing promotions, by which a merchant advertises, markets, and promotes the merchant's goods or services to a customer, can be presented to the customer as a deal offer, i.e., an offer of a discount, a benefit, a complimentary (i.e., free) item, or other deal or perk that entices or encourages the customer to purchase, use, or test the merchant's goods or services. The merchant can be a business such as a company or a sole proprietor that offers goods or services for sale or rental. The customer can be an existing or potential customer or shopper. The system includes a bar code generator, a bar code reader, a merchant computing device, a customer computing device, a remote server, and a telecommunications network. The system also includes one or more software applications. A software application providing access to a customer portal is available for download and installation on the customer computing device. Similarly, a software application providing access to a merchant portal is available for download and installation on the merchant computing device. Each merchant is assigned a unique bar code so that the merchant's deal offer and related analytics can be tracked through the merchant portal of the software application installed on the merchant computing device. In some embodiments, the system's bar code generator may generate a new bar code for each deal offer created by the merchant using the merchant portal. Access to the merchant portal may be restricted to certain employees or agents of the merchant and can include password protection.

In exemplary embodiments, the system relates to a membership-based service in which each customer registers as a member by creating a new account by providing certain personal identifying information (e.g., name, address, phone number, e-mail address, etc.) and login credentials (e.g., a user name and password) for customer account access. Similarly, each merchant also registers for a commercial account by providing certain business identifying information (e.g., name, address, phone number, e-mail address, etc.) and login credentials (e.g., a user name and password) for business account access.

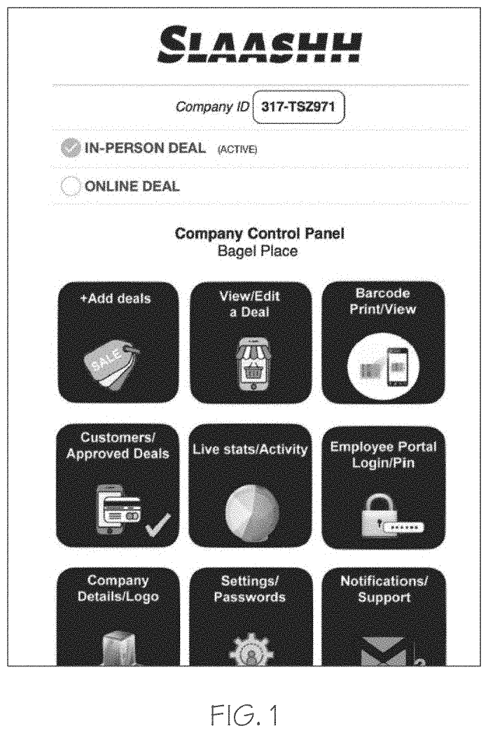

As shown in FIG. 1, the system includes a merchant portal by which merchants obtain account access and that features certain tools for creating, managing, and analyzing their marketing promotions. Merchants can use the merchant portal to administer, create, and manage their online and in-person deals, which customers who have membership accounts can access. Such deals may be exclusive only for customers who have membership accounts and may be accessed only via the system. A merchant uses the merchant portal to input its proposed deals by providing written descriptions and/or graphics that describe and represent the deal the merchant wishes to offer and promote to new customers, existing customers, or both. In some embodiments, the system may require approval by a system administrator of a new deal offer created by a merchant, so that the new deal offer appears on the customer portal and may be located by the customer via browsing the customer portal only after approval by the system administrator. In other embodiments, new deal offers may be approved or rejected by an automated process of the system. In still other embodiments, new deal offers may automatically be posted to the customer portal without any vetting or approval by the system or a system administrator.

In some embodiments of the system, the deal offers may not be exclusively for customers who are members but may be shared with other customers who do not have member accounts. For example, deals may be shared with non-member customers by customers who are members, by merchants, or by the system administrator. Sharing of deals between member customers and with non-member customers may be accomplished using the app, e-mail, text message (SMS or MMS), instant message (e.g., via WhatsApp), or any other suitable means. When deals are shared with non-member customers, information related to the deal offer may be limited or restricted in scope. For example, a deal offer shared with a non-member customer may only include a title and photo that identifies the deal offer.

Any time a merchant changes a deal or adds a new deal, the system may notify customers in a certain geographic area (e.g., within a certain proximity to or radius of the merchant). The system may provide customers with a favorites list feature that allows each customer to select a particular merchant as one of the customer's preferred or favorite merchants for addition to a favorites list maintained in connection with that customer's account. The system will notify customers who have selected a particular merchant as a favorite, or who were previously offered a deal by the merchant, of the new or changed deal through push notifications that are sent to a software application installed on the customer computing device. In other embodiments, the notifications are sent to the customer's account, wherein the customer's account is accessible online via logging into a website using a browser software application on the customer computing device.

In some embodiments, the system may also include a communication module (e.g., an instant messenger or other chat software) that permits a merchant to communicate directly with a customer who has added the merchant to the customer's favorites list.

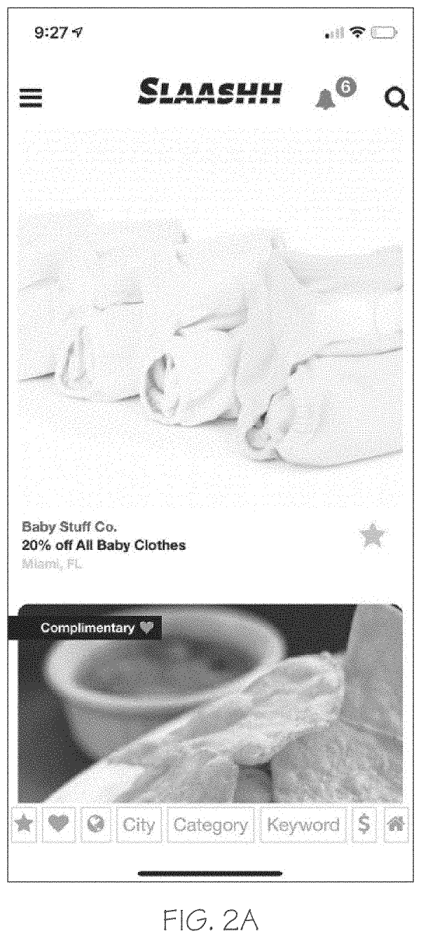

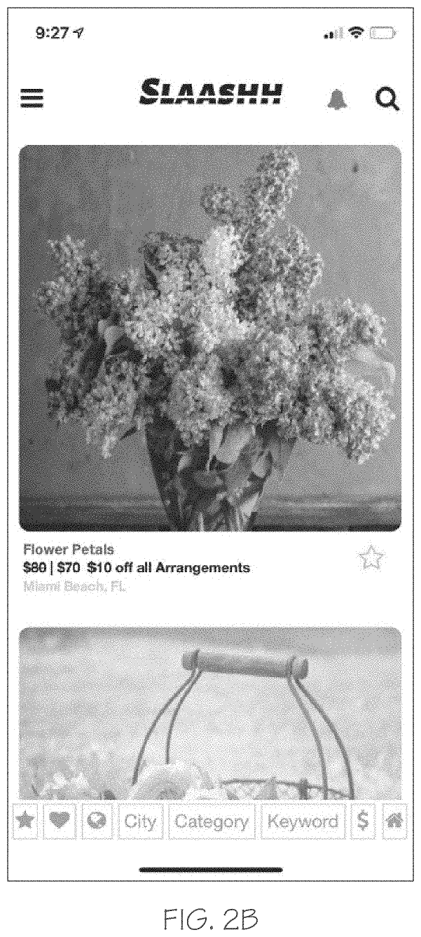

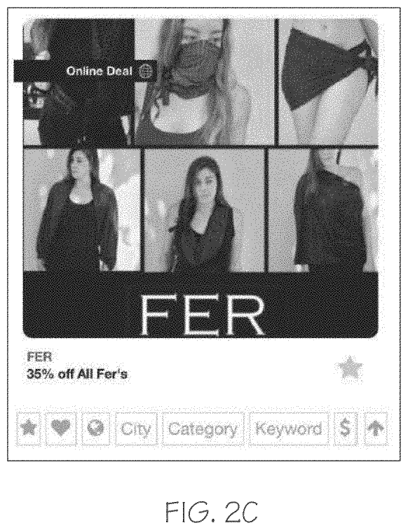

As shown in FIGS. 2A-2C, the system also includes a customer portal by which customers obtain account access and that features information concerning deal offers from merchants as well as the ability to access such deal offers for making purchases and orders.

The merchant computing device includes a processor and associated memory. The merchant computing device can be a computer (e.g., a desktop, laptop, or tablet computer), a mobile device (e.g., a smartphone), a point-of-sale computer terminal, or any other suitable computing device.

The customer computing device includes a processor and associated memory. The customer computing device can be a computer (e.g., a desktop, laptop, or tablet computer), a mobile device (e.g., a smartphone), or any other suitable computing device.

The bar code reader can be a camera and software of the customer computing device, e.g., a camera of the customer's mobile phone or a web camera connected to the customer's computer. In other embodiments, the bar code reader can be a handheld bar code scanning device, e.g., an optical bar code scanner.

The telecommunications network is a communications network, which can be wired or wireless. The telecommunications network can be the Internet, a local area network (LAN), a WiFi network, a cellular network, or any other suitable communications network.

The bar code generator can be software for generating a bar code that is displayable on a display screen of a computing device. The display screen can be connected to or an integrated part of the computing device. The merchant computing device includes an associated display device. The customer computing device also includes an associated display device. In some embodiments, the bar code generator can be installed on the remote server so that, once generated, the bar code is transmitted to the merchant computing device or to the customer computing device.

In other embodiments, the bar code generator can be installed on the merchant computing device so that the bar code, once generated, is displayable by a display screen of the merchant computing device for reading or scanning by the bar code reader. In related embodiments, the bar code may be either generated by the merchant computing device, or generated by the remote server and transmitted to the merchant computing device for printing of the bar code on paper or another medium by a printing device. The printing device is also a part of the system in such embodiments, and can be a home or offer printer. In still other embodiments, the bar code generator can be installed on the customer computing device so that the bar code, once generated, is displayed on a display screen of the customer computing device.

The system also includes a deal transaction request process, a deal transaction approval process, and a notification process. One or more of the foregoing processes may be installed on the remote server, although in some embodiments, one or more of the processes may be installed on the merchant computing device or the customer computing device. The bar code generator generates a bar code related to a deal offered by a merchant, wherein the deal includes deal data related to an offer to sell a good or service. The bar code may be displayed by the customer computing device or by the merchant computing device. In some embodiments, the bar code may be printed and displayed at a point-of-sale, e.g., in a brick-and-mortar store or at a kiosk or vending machine. The customer computing device, the merchant computing device, or both includes a bar code reader for reading the bar code. The remote server includes a deal database in which the deal data is stored. The deal transaction request process creates and transmits a deal transaction request via a telecommunications network from a customer computing device to the merchant computing device, and the deal transaction approval process receives the deal transaction request from the deal transaction request process and approves or rejects the deal transaction request. The notification process transmits an approval or rejection notification to the customer computing device as an alert that the deal transaction request has been accepted or rejected.

In the merchant portal, each merchant has access to detailed analytics including which of its deals are the most popular among users, profitability of deals, performance, approvals and rejections of deals, amounts spent, and deals favorited or abandoned by particular customers.

As explained elsewhere herein, the system may be used to provide and to access both online deals and in-person (i.e., in-store) deals. Examples of various embodiments of the system and how they operate are set forth in the following paragraphs.

In-Store Deal Offers

For in-person deals, a customer scans the merchant's bar code at the merchant's store, kiosk, vending machine, or other point-of-sale location to obtain access to the deal being offered by the merchant. When the customer scans the in-store bar code, a deal transaction request process of the software application (also referred to as the “app”) installed on the customer computing device generates a deal transaction request that is transmitted by the telecommunications network to the remote server, and the remote server sends a notification to the merchant via the deal transaction approval process that accessible by the merchant via the merchant portal to either accept (approve) or reject (deny) the deal transaction request. Such access may also include a pre-approval process whereby the merchant or the system administrator must approve the deal requested by the customer before the customer is permitted by the system to receive the deal. In exemplary embodiments, the customer scans the merchant's bar code using the camera of the customer's mobile phone. After the in-store bar code is scanned, the merchant receives a notification through the deal transaction approval process of the merchant portal that the customer scanned the in-store bar code. When the customer is ready for checkout utilizing the deal associated with the in-store bar code to make a purchase, the merchant must log into the merchant portal to locate and approve the scanned in-store bar code so that the customer may receive the in-person deal when making the purchase of goods or services associated with the deal offer. In other embodiments, the merchant's approval may be automated without requiring approval from the merchant via the merchant portal each time an in-store bar code is scanned by a customer. The system may also include a control feature that permits a merchant to toggle between “automated approval” and “manual approval” for approving deals requested by customers.

In embodiments of the system that include automated approval by the system rather than manual approval by a system administrator (or in which an “automated approval” control feature is enabled), when a customer visits a merchant's store or other business location, the customer will scan the displayed barcode using the camera of the customer's mobile phone on which the system's app is installed. The system then generates an approval notification through an automated process that is displayed on the customer's mobile phone, e.g., in the app. No action is required by the merchant to approve the deal as the system automatically approves the deal. The merchant may view and monitor such automated deal approvals in the merchant portal.

The system may also include a “check in” feature whereby merchants record a customer's visit to the merchant's store or other business location when the customer scans the displayed barcode. In some embodiments, the “check in” feature also records the amount a customer spends, saves by taking advantage of the deal, or both. The “check in” feature may also record other statistics related to automated approval of deal requests submitted by customers through the app, which are displayed in the merchant portal.

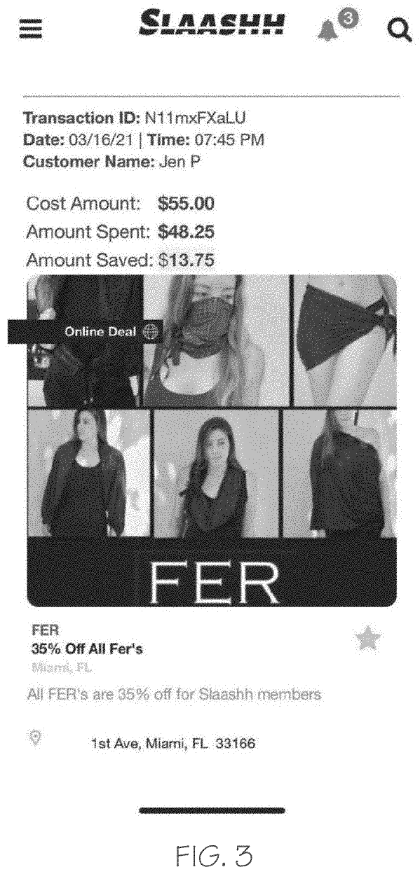

Upon the merchant's approval of the in-store bar code deal requested by the customer by scanning the in-store bar code, the customer receives an approval notification that the deal is granted. In some embodiments of the system, this approval notification may be on a purchase confirmation page (for example, as shown in FIG. 3) or on a separate approval notification page that is displayed to the customer before the purchase confirmation page is displayed. If the merchant denies or rejects the deal transaction request, a notification will appear in the merchant portal and the customer will receive a rejected notification in the customer portal of the app installed on the customer computing device. If the bar code cannot be scanned or the bar code reader is not properly communicating with the remote server, the merchant can also approve the deal transaction request from the customer manually by inputting the requested information into the merchant portal.

Online Deal Offers

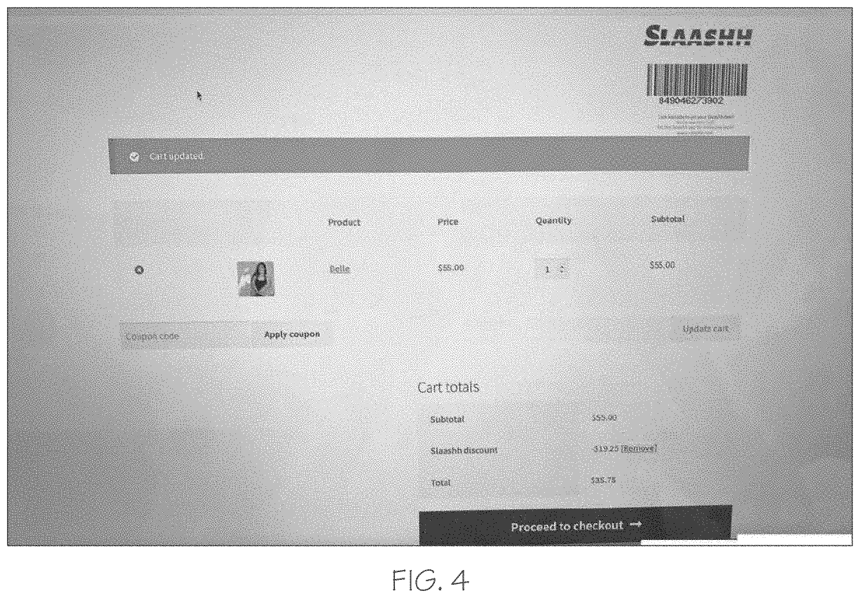

For merchants to allow deal offers to be presented through their websites, the system includes a plugin, i.e., a software add-on, which is added to a merchant's website to activate the online deals feature. As shown in FIG. 4, after adding the plugin to its website, the merchant's bar code created specifically for the merchant by the system's bar code generator will appear on a checkout page of the merchant's website. Customers, who have created a member account through the system, will be able to redeem an online deal offer in any of three different ways:

1. If the customer is accessing the system using a personal computer as the customer computing device, then the customer can click on or otherwise select the bar code using a computer mouse or other input device that is communicatively connected to the computer. The customer then inputs the customer's user name or member ID in the customer portal. After entering the customer's user name or member ID in the customer portal, the customer receives a notification from the app that prompts the customer to click on or otherwise select a request to receive the deal (e.g., an icon such as a “yes, get this deal” button). The system then populates information related to the deal on the checkout page of the merchant's website so that the customer may complete the transaction.

2. If the customer is accessing the system using a personal computer as the customer computing device and is ready for checkout to complete a purchase using the deal offer, the customer can locate the deal offer on the app (for example, when the app is installed on the customer's mobile phone or desktop computer) and scan the bar code associated with the deal offer using the bar code reader (which is generally a camera of a mobile phone device). The system then populates information related to the deal on the checkout page of the merchant's website so that the customer may complete the transaction.

3. If the customer is accessing the system using the app (e.g., when the app is installed on the customer's mobile phone as a customer computing device), the customer may access the merchant's website directly via the app. Once the customer is ready to check out, the customer may click on or otherwise select the bar code on the merchant's website and doing so will open the app. The customer receives a notification from the app that prompts the customer to click on or otherwise select a request to receive the deal (e.g., an icon such as a “yes, get this deal” button). The system then populates information related to the deal on the checkout page of the merchant's website so that the customer may complete the transaction.

After a purchase is made using the system, a purchase transaction page may be displayed which shows purchase information. Purchase information can include, for example, the customer's name or other personally identifying information, an original price for the good or service purchased by the customer, the amount actually spent by the customer after application of the deal to the purchase, and the amount saved. If the deal offer relates to a complimentary item, the system may only display the amount spent, which would be zero for that item.

The system may also include a social media feature that allows customers to post messages and images to one another, to merchants, or both.

The system may also include a feature by which expired deal offers continue to be displayed by the system (e.g., either on the customer portal in the app or in a web version of the customer portal that is accessible via a browser) for a predetermined period of time after their expiration. Customers may use the customer portal to submit a request to a merchant with an expired deal to renew that deal offer. The merchant may elect to renew the expired deal offer (or not) based on such requests.

The system includes a special menu generation process for use by merchants that operate restaurants. Using the special menu generation process of the system, a restaurant merchant can generate a special menu with special (e.g., discounted) prices for customers who are member-users of the system. For example, the special menu may include certain menu items selected by the merchant from the merchant's standard menu and offered at discounted prices to such member-users, or all of the merchant's menu items may be offered on the special menu at discounted prices. Similarly, the system may include a combined services pricing process that allows merchants to offer special discounted pricing for multiple services purchased by a customer. This feature can be useful for merchants who offer multiple services, e.g., gyms that offer Pilates classes or other additional paid services.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for creating, managing, and analyzing marketing promotions, the system comprising:
a bar code generator for generating a bar code related to a deal offered by a merchant, wherein the deal comprises deal data related to an offer to sell a good or service of the merchant;
a merchant computing device comprising a processor and associated memory;
a customer computing device comprising a processor and associated memory;
a bar code reader for reading the bar code, wherein the bar code reader is communicatively connected to the merchant computing device or the customer computing device;
a remote server comprising a deal database in which the deal data related to the deal is stored;
a telecommunications network for connecting the merchant computing device and the customer computing device to the remote server;
a deal transaction request process for creating and transmitting a deal transaction request from the customer computing device of a customer to the merchant computing device of the merchant;
a deal transaction approval process, installed on the remote server, for receiving the deal transaction request from the deal transaction request process and for approving or rejecting the deal transaction request; and
a notification process, installed on the remote server, for transmitting an approval notification or a rejection notification to the customer computing device to alert the customer as to whether the merchant has accepted or rejected the deal transaction request.
